(19) United States
(12) Patent Application Publication
(10) Pub. No.: US 2016/0378048 A1
(43) Pub. Date: Dec. 29, 2016

(54) IMAGE FORMING APPARATUS INCORPORATING GUIDING DEVICE

(71) Applicants: Mitsuhiro SUGAWARA, Kanagawa (JP); Norihisa KAKINUMA, Kanagawa (JP)

(72) Inventors: Mitsuhiro SUGAWARA, Kanagawa (JP); Norihisa KAKINUMA, Kanagawa (JP)

(73) Assignee: Ricoh Company, Ltd., Tokyo (JP)

(21) Appl. No.: 15/178,924

(22) Filed: Jun. 10, 2016

(30) Foreign Application Priority Data
Jun. 24, 2015 (JP) 2015-126350
May 12, 2016 (JP) 2016-095733

(51) Int. Cl. G03G 15/00

(52) U.S. Cl. CPC G03G 15/70

(57) ABSTRACT

An image forming apparatus includes an apparatus body, an image forming device detachably attached to the apparatus body, a sheet conveying path through which a recording medium travels, a roller disposed along the sheet conveying path, a rotary body configured to rotate the roller manually to remove the recording medium in paper jam, and a guiding device.

The guiding device includes a sheet detector disposed along the sheet conveying path to detect the recording medium passing through the sheet conveying path and a guide to suggest removal of the image forming device to remove the recording medium in paper jam when the sheet detector no longer detects the recording medium. The guide also suggests removal of the image forming device when the sheet detector detects the recording medium after a predetermined number of rotations of the rotary body.

### CROSS-REFERENCE TO RELATED APPLICATIONS

This patent application is based on and claims priority pursuant to 35 U.S.C. §119(a) to Japanese Patent Application Nos. 2015-126350, filed on Jun. 24, 2015, and 2016-095733, filed on May 12. 2016, in the Japan Patent Office, the entire disclosure of each of which is hereby incorporated by reference herein.

### BACKGROUND

Technical Field

This disclosure relates to an image forming apparatus incorporating a guiding device.

Related Art

Various types of image forming apparatuses includes copiers, printers, facsimile machines, or multifunction peripherals (MFPs) having two or more of copying, printing, scanning, facsimile transmission, plotter, and other capabilities. Such image forming apparatuses include a manual rotation knob to remove a jammed sheet or jammed sheets from the image forming apparatus.

Such an image forming apparatus includes multiple sheet detecting sensors to detect a sheet along a sheet conveying path, so that it is determined whether or not paper jam has occurred based on results detected by the sheet detecting sensors. When the paper jam was detected, the manual rotation knob is turned to remove the jammed sheet from a nip region formed between rollers holding the jammed sheet. When the sheet detecting sensors stop detecting any paper jam after removal of the jammed sheet, a light emitting diode mounted on a front face of a unit of the image forming apparatus starts flashing to draw user's attention to remove the unit.

By removing the unit, the jammed sheet that has been ejected from the nip region between the rollers is removed,

### SUMMARY

At least one aspect of this disclosure provides an image forming apparatus including an apparatus body, an image forming device disposed detachably attached to the apparatus body, a sheet conveying path through which a recording medium travels in the image forming device, a roller disposed along the sheet conveying path, a rotary body configured to rotate the roller manually to remove the recording medium in paper jam, and a guiding device. The guiding device includes a sheet detector and a guide. The sheet detector is disposed along the sheet conveying path to detect the recording medium passing through the sheet conveying path. The guide is configured to suggest removal of the image forming device to remove the recording medium in paper jam when the sheet detector no longer detects the recording medium. The guide is also configured to suggest removal of the image forming device when the sheet detector detects the recording medium after a predetermined number of rotations of the rotary body.

### BRIEF DESCRIPTION OF THE SEVERAL VIEWS OF THE DRAWINGS

FIG. 1 is a perspective view illustrating an image forming apparatus with a guiding device, according to Example 1 of this disclosure, the guiding device in a state in which a front cover door is open;

FIG. 2 is a diagram illustrating a schematic configuration of a fixing device and a duplex printing device included in the image forming apparatus;

FIG. 3 is a block diagram illustrating a configuration of a control system included in the image forming apparatus according to Example 1;

FIG. 4A is a circuit diagram illustrating a configuration of the guiding device provided to the fixing device;

FIG. 4B is a circuit diagram illustrating a configuration of the guiding device provided to the duplex printing device;

FIG. 5 is a flowchart showing operations of the guiding device of FIGS. 4A and 4B; and

FIG. 6 is a block diagram illustrating a configuration of a control system included in the image forming apparatus according to Example 2 of this disclosure.

### DETAILED DESCRIPTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. it will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

Although the terms first, second, etc. may be used herein to describe various elements, components, regions, layers and/or sections, it should be understood that these elements, components, regions, layer and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

The terminology used herein is for describing particular embodiments and examples and is not intended to be limiting of exemplary embodiments of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of an image forming apparatus according to exemplary embodiments of this disclosure. Elements having the same functions and shapes are denoted by the same reference numerals throughout the specification and redundant descriptions are omitted. Elements that do not demand descriptions may be omitted from the drawings as a matter of convenience. Reference numerals of elements extracted from the patent publications are in parentheses so as to be distinguished from those of exemplary embodiments of this disclosure.

This disclosure is applicable to any image forming apparatus, and is implemented in the most effective manner in an electrophotographic image forming apparatus.

In describing preferred embodiments illustrated in the drawings, specific terminology is employed for the sake of clarity. However, the disclosure of this disclosure is not intended to be limited to the specific terminology so selected and it is to be understood that each specific element includes any and all technical equivalents that have the same function, operate in a similar manner, and achieve a similar result.

Referring now to the drawings, wherein like reference numerals designate identical or corresponding parts throughout the several views, preferred embodiments of this disclosure are described.

Now a description is given of an image forming apparatus with a guiding device according to an embodiment of this disclosure with reference to drawings.

### Embodiment 1

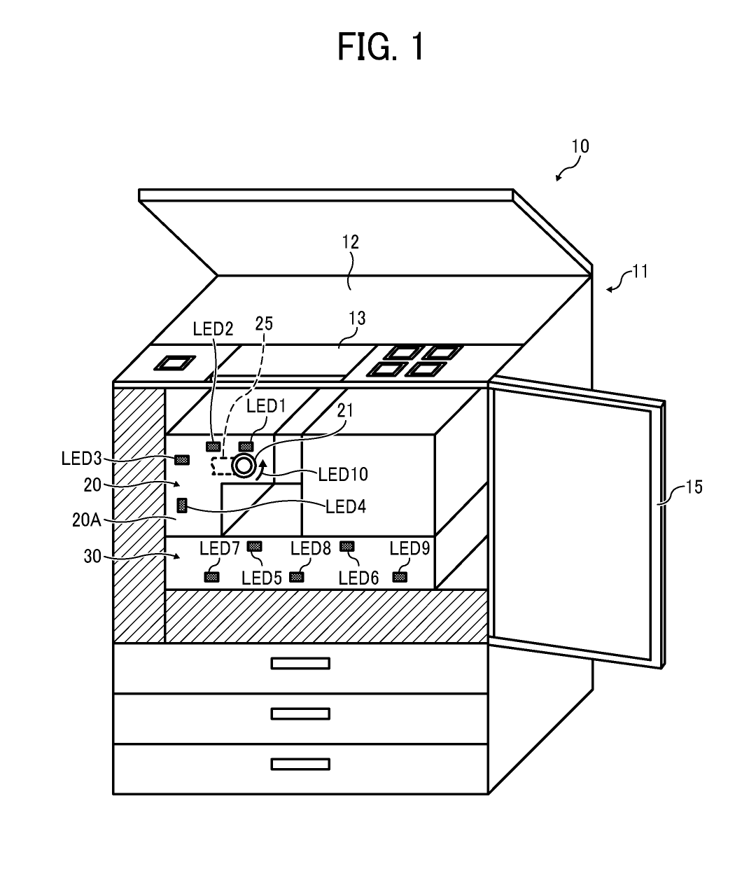

FIG. 1 is a illustrating an image forming apparatus 10 according to Embodiment 1 of this disclosure.

It is to be noted that identical parts are given identical reference numerals and redundant descriptions are summarized or omitted accordingly.

The image forming apparatus 10 may be a copier, a facsimile machine, a printer, a multifunction peripheral or a multifunction printer (MFP) having at least one of copying, printing, scanning, facsimile, and plotter functions, or the like. According to the present example, the image forming apparatus 10 is an electrophotographic copier that forms toner images on recording media by electrophotography.

It is to be noted in the following examples that: the term “image forming apparatus” indicates an apparatus in which an image is formed on a recording medium such as paper, OHP (overhead projector) transparencies, OHP film sheet, thread, fiber, fabric, leather, metal, plastic, glass, wood, and/or ceramic by attracting developer or ink thereto; the term “image formation” indicates an action for providing (i.e., printing) not only an image having meanings such as texts and figures on a recording medium but also an image having no meaning such as patterns on a recording medium; and the term “sheet” is not limited to indicate a paper material but also includes the above-described plastic material (e.g., a OHP sheet), a fabric sheet and so forth, and is used to which the developer or ink is attracted. In addition, the “sheet” is not limited to a flexible sheet but is applicable to a rigid plate-shaped sheet and a relatively thick sheet.

Further, size (dimension), material, shape, and relative positions used to describe each of the components and units are examples, and the scope of this disclosure is not limited thereto unless otherwise specified.

Further, it is to be noted in the following examples that: the term “sheet conveying direction” indicates a direction in which a recording medium travels from an upstream side of a sheet conveying path to a downstream side thereof; the term “width direction” indicates a direction basically perpendicular to the sheet conveying direction.

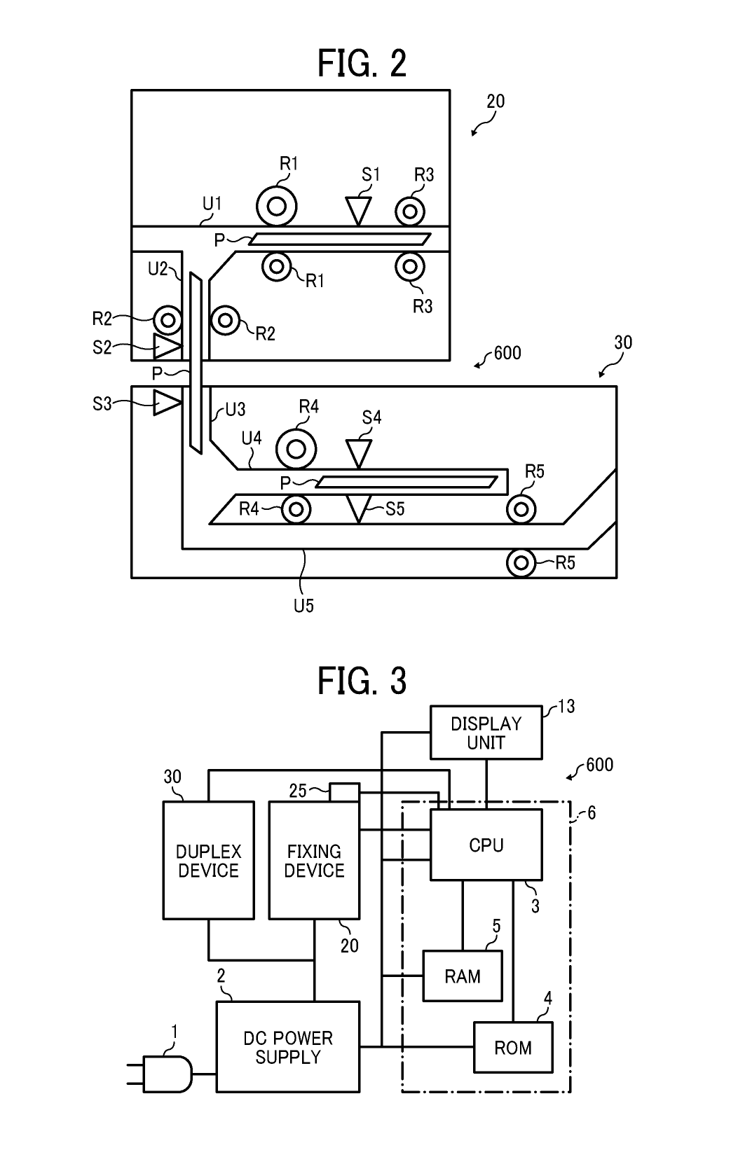

As illustrated in FIG. 1, the image forming apparatus 10 includes an apparatus body 11. Inside the apparatus body 11, a fixing device 20, a duplex printing device 30, and so forth are included. The duplex printing device 30 forms images on both sides of a sheet P (see FIG. 2). The fixing device 20 and the duplex printing device 30 are provided for image formation. Both of the fixing device 20 and the duplex printing device 30 are detachably attached to the apparatus body 11 of the image forming apparatus 10. The fixing device 20 is disposed upstream from the duplex printing device 30 in a sheet conveying direction.

Further, the apparatus body 11 has an upper face on which an exposure glass 12 and a control display unit 13 are mounted.

Configuration and Functions of Fixing Device.

Light emitting diodes LED1 through LED4 and LED10 and a manual rotation knob 21. The light emitting diode LED10 draws user's attention to manually operate the manual rotation knob 21. The light emitting diodes LED1 through LED4 are aligned along sheet conveying paths U1 and U2 (see FIG. 2).

The manual rotation knob 21 is turned to rotate pairs of rollers R1 and R2 arranged in the sheet conveying path U1. As the pairs of rollers R1 and R2 rotate, a jammed sheet is conveyed toward a downstream side in the sheet conveying direction. By so doing, a paper jam is eliminated, that is, paper jam can be handled successfully.

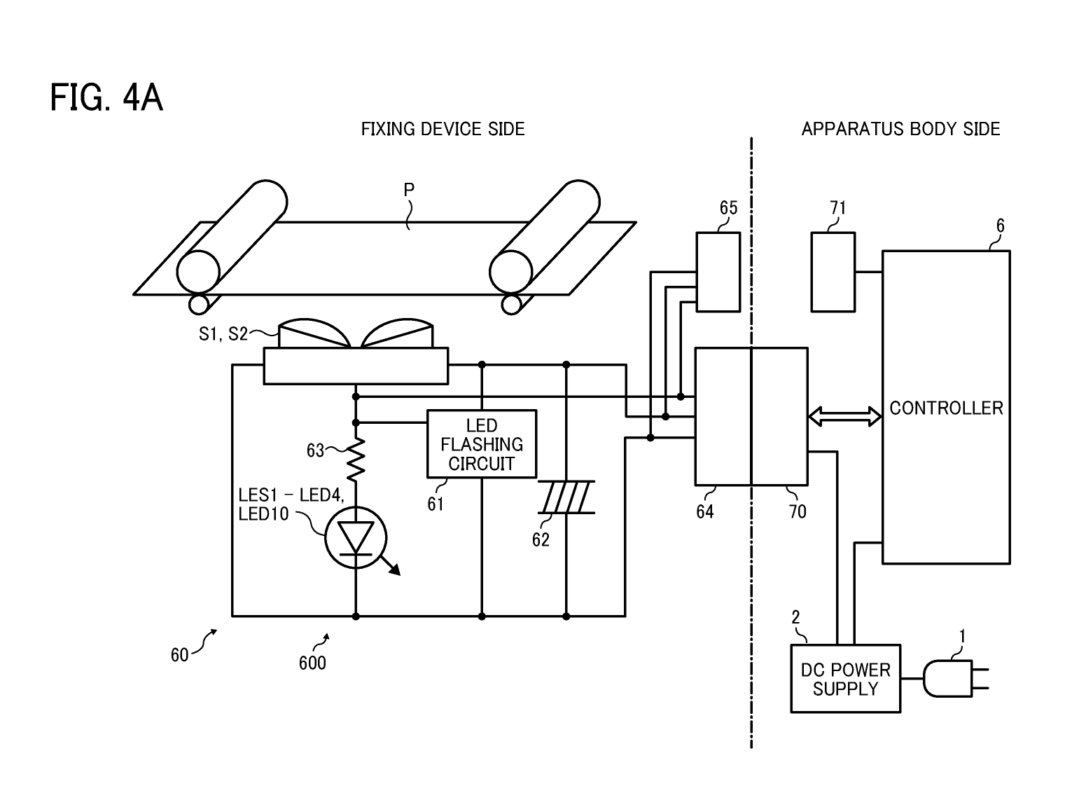

By so doing, a paper jam is eliminated, that is, paper jam can be handled successfully. The rotation detecting portion 25 outputs a pulse by one cycle, for example. A central processing unit (CPU) 3 (see FIG. 3) counts up the number of pulses. The rotation detecting portion 25 and the CPU 3 form a rotation detector to detect the number of rotations of the manual rotation knob 21.

Further, the fixing device 20 includes the sheet conveying paths U1 and U2. As illustrated in FIG. 2, the sheet conveying path U1 extends in a horizontal direction through the fixing device 20 and the sheet conveying path U2 extends downwardly from a position near a sheet ejecting port, that is, a downstream end of the sheet conveying path U1. The pair of rollers R1, a pair of rollers R3, and a sheet detecting sensor S1 are arranged along the sheet conveying path U1. The pair of rollers R2 and a sheet detecting sensor S2 are arranged along the sheet conveying path U2.

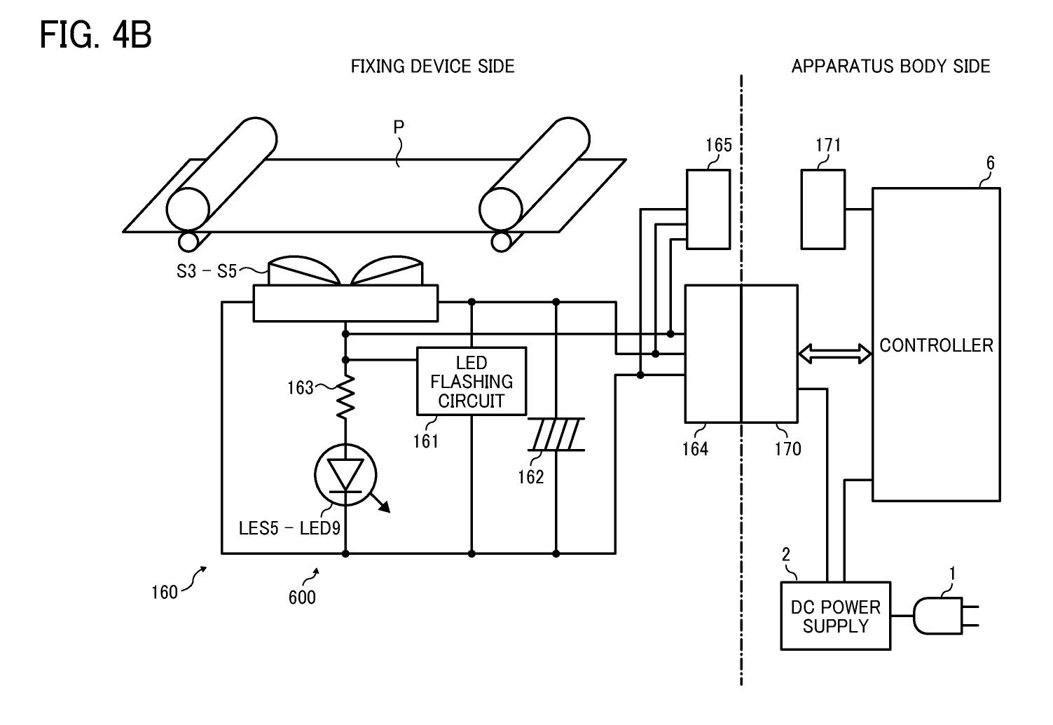

The fixing device 20 includes a first guiding circuit 60 (see FIG. 4A) to display a paper jam status and draw user's attention to remove the fixing device 20.

Duplex Printing Device.

As illustrated in FIG. 1, multiple light emitting diodes LED5 through LED9 are aligned along sheet conveying paths U4 and U5 (see FIG. 2).

As illustrated in FIG. 2, Further, the duplex printing device 30 includes a sheet conveying path U3 and the sheet conveying paths U4 and U5. The sheet conveying path U3 extends vertically and the sheet conveying paths U4 and U5 formed along the horizontal direction. A sheet detecting sensor S3 is disposed above the sheet conveying path U3. A pair of rollers R4 and a sheet detecting sensor S4 are arranged along the sheet conveying path U4. A pair of rollers R2 and a sheet detecting sensor S5 are arranged along the sheet conveying path U5.

The duplex printing device 30 includes a second guiding circuit 160 (see FIG. 4B) to display a paper jam status and draw user's attention to remove the duplex printing device 30.

Control System.

FIG. 3 is a block diagram illustrating a configuration of a control system included in the image forming apparatus 10 according to Embodiment 1.

The control system of the image forming apparatus 10 includes an outlet 1, a direct current (DC) power supply 2, and a controller 6. The outlet 1 connects with a commercial power supply AC100V. The DC power supply 2 converts from the commercial power supply to the DC power supply 2. The controller 6 controls the fixing device 20, the duplex printing device 30, and other device.

The controller 6 includes the CPU 3, a read-only memory (ROM) 4, and a random access memory (RAM) 5. The CPU 3 of the controller 6 performs various controls for image formation. The ROM 4 stores programs executed by the CPU 3 of the controller 6. The RAM 5 is used as a work memory.

However, in a comparative image forming apparatus, in a case in which a jammed sheet is caught around a sheet conveying path, the jammed sheet cannot be removed from a nip region occasionally even if a manual rotation knob is turned. In such a case, sheet detecting sensors keep detecting jammed papers. Therefore, a light emitting diode cannot be flashed, and a user cannot be notified that it is ready to remove an image forming unit. As a result, the user cannot handle the paper jam.

First Guiding Circuit.

As illustrated in FIG. 4, the first guiding circuit 60 includes the sheet detecting sensors S1 and S2, the light emitting diodes LED1 through LED4 and LED10, an LED flashing circuit 61, a capacitor 62, a resistor 63, an internal connector 64, and an infrared transmitter-receiver 65. The internal connector 64 is mounted on a rear face of the fixing device 20 and is connected to an apparatus body connector 70 mounted on the apparatus body 11. When the fixing device 20 is pulled out from the apparatus body 11, the internal connector 64 is disconnected from the apparatus body connector 70. By contrast, when the fixing device 20 is attached to the apparatus body 11, the internal connector 64 is connected to the apparatus body connector 70.

The capacitor 62 is electrically charged by the DC power supply 2 while the internal connector 64 is connected to the apparatus body connector 70.

Detection signals detected by the sheet detecting sensors S1 and S2 are inputted to the CPU 3 of the controller 6 via the internal connector 64 and the apparatus body connector 70. The CPU 3 determines whether or not a paper jam occurs and the position of the paper jam based on the detection signals. Then, a flashing signal and a lighting signal with respect to the light emitting diodes LED1 through LED4 are transmitted to the LED flashing circuit 61 via the apparatus body connector 70 and the internal connector 64. The flashing signal flashes or blinks a corresponding one of the light emitting diodes LED1 through LED4 at the position where the paper jam has occurred. The lighting signal lights on the corresponding one. Further, the light emitting diode LED10 instructs rotation of the manual rotation knob 21 based on the detection results. The CPU 3 of the controller 6 transmits a flashing signal and a lighting signal with respect to the light emitting diode LED10 is transmitted to the LED flashing circuit 61 via the apparatus body connector 70 and the internal connector 64. The flashing signal flashes or blinks a corresponding one of the light emitting diode LED10 at the position where the paper jam has occurred. The lighting signal lights on the light emitting diode LED 10.

The LED flashing circuit 61 flashes or lights on the light emitting diodes LED1 through LED4 located at the jammed position and the light emitting diode LED10 that guides rotation of the manual rotation knob 21 based on the flashing signal and the lighting signal.

When the fixing device 20 is pulled out from the apparatus body 11, the internal connector 64 is disconnected from the apparatus body connector 70, and the DC power supply 2 is cut. However, the LED flashing circuit 61 remains under operation due to charged current of the capacitor 62, so that the light emitting diodes LED1 through LED4 and LED10 keep flashing and blinking.

The detection signals detected by the sheet detecting sensors S1 and S2 are inputted to the CPU 3 via the infrared transmitter-receiver 65 and an infrared transmitter-receiver 71 of the apparatus body 11 even when the internal connector 64 and the apparatus body connector 70 are not connected to each other. The CPU 3 determines whether or not paper jam handling is finished or any sheets are left based on the detection a signal detected by the sheet detecting sensors S1 and S2, and outputs signals to flash, light on, or light off the light emitting diodes LED1 through LED4 and LED 10. The signal is inputted to the LED flashing circuit 61 via the infrared transmitter-receiver 71 and the infrared transmitter-receiver 65.

The LED flashing circuit 61 flashes and lights on the light emitting diodes LED1 through LED4 and LED 10 based on the inputted signal. By so doing, the LED flashing circuit 61 draws user's attention to remove the fixing device 20 and informs completion of the paper jam handling.

Second Guiding Circuit.

As illustrated in FIG. 4B, the second guiding circuit 160 includes the sheet detecting sensors S3, S4, and S5, the light emitting diodes LED5 through LED9 and LED10, an LED flashing circuit 161, a capacitor 162, a resistor 163, an internal connector 164, and an infrared transmitter-receiver 165. The internal connector 164 is mounted on the rear face of the fixing device 20 and is connected to an apparatus body connector 170 mounted on the apparatus body 11. It is to be noted that, similar to the first guiding circuit 60, detection signals detected by the sheet detecting sensors S3 through S5 are inputted to the CPU 3 via the infrared transmitter-receiver 165 and an infrared transmitter-receiver 171 of the apparatus body 11 even when the internal connector 164 and the apparatus body connector 170 are not connected to each other.

The second guiding circuit 160 performs operations basically identical to the first guiding circuit 60. Therefore, the description of the operations performed by the second guiding circuit 160 is omitted here.

In Embodiment 1, the first guiding circuit 60, the second guiding circuit 160, and the controller 6 form a guiding device 600.

Operations.

Next, a description is given of operations of the image forming apparatus 10 having the above-described configuration.

When the image forming apparatus 10 performs image forming operations normally, each time the sheet P passes through the sheet conveying paths U1 and U2 of the fixing device 20 and the sheet conveying path U3 through U5 of the duplex printing device 30, the sheet detecting sensors S1 through S5 detect the passage of the sheet P and output respective detection signals. When a paper jam occurs, any of the sheet detecting sensors S1 through S5 stops outputting the detection signal at a certain timing. Consequently, the CPU 3 of the controller 6 determines that the paper jam has occurred before the corresponding one of the sheet detecting sensors S1 through S5 is disposed. Further, in a case in which any of the sheet detecting sensors S1 through S5 keeps outputting the detection signal, the CPU 3 of the controller 6 also determines that the paper jam has occurred at a position where the corresponding one of the sheet detecting sensors S1 through S5 is disposed.

The CPU 3 sends instructions to the control display unit 13 of the apparatus body 11 based on the detection signals of the sheet detecting sensors S1 through S5, so that the control display unit 13 displays information of occurrence of the paper jam and the location of the paper jam.

Further, the CPU 3 of the controller 6 causes any of the light emitting diodes LED1 through LED4 of the fixing device 20 and any of the light emitting diodes LED5 through LED9 to flash or light on so as to indicate the position where the paper jam has occurred. The CPU 3 further causes the light emitting diode LED 10 that guides rotation of the manual rotation knob 21 to flash or light on.

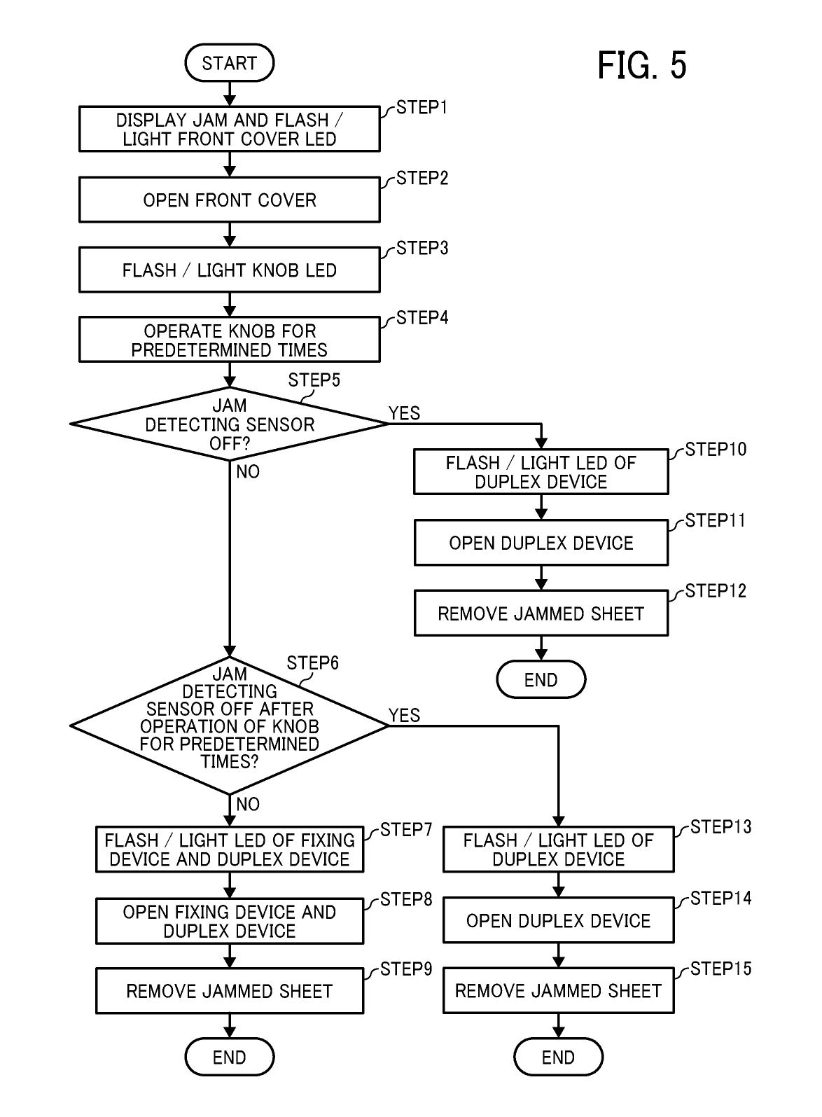

FIG. 5 is a flowchart showing operations of the guiding device 600 in a case in which the sheet detecting sensor S2 keeps outputting a detection signal, that is, a case in which a paper jam has occurred at the location of the sheet detecting sensor S2, for example.

In STEP 1, after a paper jam has occurred, the control display unit 13 of the apparatus body 11 displays information of occurrence of the paper jam and the location of the paper jam. Further, the light emitting diode LED4 flashes or lights on.

In STEP 2, a user sees the information displayed on the control display unit 13 of the apparatus body 11 and opens a front door cover 15 of the apparatus body 11, as illustrated in FIG. 1.

Since the CPU 3 of the controller 6 causes the light emitting diode LED4 of the fixing device 20 to flash or light on, the user becomes aware of occurrence of a paper jam near the light emitting diode LED4 of the fixing device 20.

In STEP 3, the CPU 3 of the controller 6 causes the light emitting diode LED10 to flash or light on. By flashing or lighting the light emitting diode LED10, rotation of the manual rotation knob 21 is guided.

In STEP 4, the user turns the manual rotation knob 21 manually in response to the notification of the rotation of the manual rotation knob 21 by flashing or lighting the light emitting diode LED10. With the rotation of the manual rotation knob 21, the pairs of rollers R1 and R2 gradually rotate to move the jammed sheet toward a downstream side in the sheet conveying direction. That is, the jammed sheet is conveyed to the duplex printing device 30.

In STEP 5, the CPU 3 of the controller 6 determines whether the sheet detecting sensor S2 has not kept detecting the jammed sheet, in other words, whether or not the sheet detecting sensor S2 has stopped detecting the jammed sheet. When the sheet detecting sensor 52 has no more detected the jammed sheet, that is, the sheet detecting sensor S2 has stopped detecting the jammed sheet (YES in STEP 5), the jammed sheet is conveyed to the duplex printing device 30. Then, the procedure goes to STEP 10.

In STEP 10, the CPU 3 of the controller 6 causes the light emitting diodes LED5 through LED9 of the duplex printing device 30 to flash or light on to draw user's attention to remove the duplex printing device 30. At this time, the sheet detecting sensor 52 is turned off. Accordingly, the sheet detecting sensor S4 is turned off.

In STEP 11, the user pulls out the duplex printing device 30 from the apparatus body 11.

In STEP 12, the user removes the jammed sheet from the image forming apparatus 10. Due to this removal of the jammed sheet, the sheet detecting sensor S3 no longer detects the jammed sheet, and therefore the light emitting diodes LED5 through LED9 of the duplex printing device 30 are turned off.

When the sheet detecting sensor S2 keeps detecting the jammed sheet, that is, the sheet detecting sensor S2 has not stopped detecting the jammed sheet (NO in STEP 5), the procedure goes to STEP 6.

In STEP 6, the CPU 3 determines whether or not the sheet detecting sensor S2 has been turned off after the user has turned the manual rotation knob 21 by a predetermined number of times. That is, the CPU 3 determines whether or not the sheet detecting sensor S2 stops detecting the jammed sheet after the user has turned the manual rotation knob 21 by the predetermined number of times.

When the sheet detecting sensor S2 has been turned off, in other words, the sheet detecting sensor S2 has stopped detecting the jammed sheet after the user has turned the manual rotation knob 21 by the predetermined number of times (YES in STEP 6), the procedure goes to STEP 13.

In STEP 13, the CPU 3 of the controller 6 causes the light emitting diodes LED5 through LED9 of the duplex printing device 30 to flash or light on to draw user's attention to remove the duplex printing device 30. At this time, the sheet detecting sensor S2 is turned off. Accordingly, the sheet detecting sensor S4 is also turned off.

In STEP 14, the user pulls out the duplex printing device 30 from the apparatus body 11.

In STEP 15, the user removes the jammed sheet from the image forming apparatus 10. Due to this removal of the jammed sheet, the sheet detecting sensor S3 no longer detects the jammed sheet, and therefore the light emitting diodes LED5 through LED9 of the duplex printing device 30 are turned off.

When the sheet detecting sensor 52 has not been turned off, in other words, the sheet detecting sensor S2 keeps detecting the jammed sheet after the user has turned the manual rotation knob 21 by the predetermined number of times (NO in STEP 6), the procedure goes to STEP 7.

In STEP 7, since the sheet detecting sensor S2 keeps detecting the jammed sheet even after the user has turned the manual rotation knob 21 by the predetermined number of dines, the CPU 3 of the controller 6 determines that the sheet P lies across the fixing device 20 and the duplex printing device 30, as illustrated in FIG. 2. Therefore, the CPU 3 causes the light emitting diodes LED1 through LED4 of the fixing device 20 and the light emitting diodes LED5 through LED9 of the duplex printing device 30 to flash or light on. By flashing or lighting the light emitting diodes LED1 through LED9, the CPU 3 notifies the user to remove the fixing device 20 and the duplex printing device 30.

In STEP 8, the user pulls out the fixing device 20 and the duplex printing device 30 from the apparatus body 11 in response to the notification with the flashing or lighting of the light emitting diodes LED1 through LED9.

In STEP 9, the user removes the jammed sheet from the image forming apparatus 10. Due to this removal of the jammed sheet, the sheet detecting sensors S2 and S3 no longer detect the jammed sheet, and therefore the light emitting diodes LED1 through LED4 of the fixing device 20 and the light emitting diodes LED5 through LED9 of the duplex printing device 30 are turned off.

As described above, when a paper jam occurs, in a case in which the sheet detecting sensor S2 keeps detecting the jammed sheet even after the user has turned the manual rotation knob 21 by the predetermined number of times, the CPU 3 causes the light emitting diodes LED1 through LED4 of the fixing device 20 and the light emitting diodes LED5 through LED9 of the duplex printing device 30 to flash or light on. According to the above-described configuration, removal of the fixing device 20 and the duplex printing device 30 is guided appropriately. Therefore, inconvenience that a paper jam handling cannot be performed at an appropriate timing can be eliminated.

### Embodiment 2

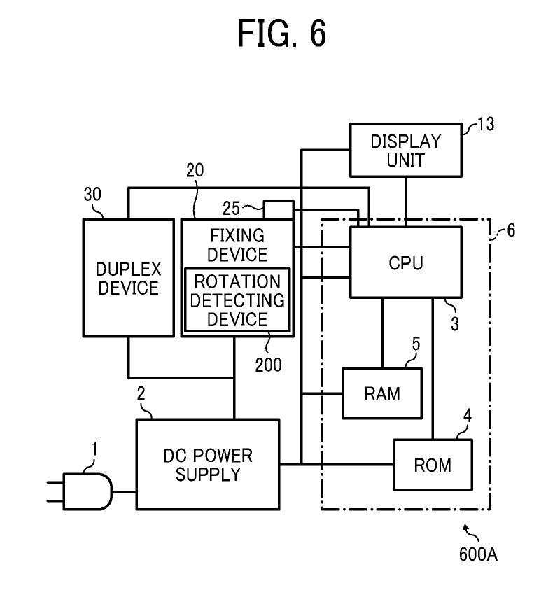

Now, a description is given of a control system of the image forming apparatus 10 with a guiding device 600A according to Embodiment 2 of this disclosure with reference to FIG. 6.

FIG. 6 is a block diagram illustrating a configuration of a control system included in the image forming apparatus according to Embodiment 2 of this disclosure.

As illustrated in FIG. 6, the pairs of rollers R1, R2, and R3 (see FIG. 3) provided to the fixing device 20 are rotated by at least one driving motor. Each of the at least one driving motor includes a rotation detecting device 200 such as an encoder.

In performing STEP 6 in Embodiment 1, the CPU 3 of the controller 6 determines whether or not the manual rotation knob 21 has been turned by the predetermined number of rotations. In Embodiment 2, the number of rotations of the manual rotation knob 21 is detected based on an output of the rotation detecting device 200. That is, as the manual rotation knob 21 is turned, the driving motor rotates together with the pairs of rollers R1, R2, and R3 as a single unit. Then, the rotation detecting device 200 detects the number of rotations of the driving motor. Since these numbers of rotations of the driving motors are relatively proportional to each other, the number of rotations of the manual rotation knob 21 can be detected based on the number of rotations detected by the rotation detecting device 200.

Accordingly, in addition to the effect achieved by the configuration of Embodiment 1, a sensor that detects the number of rotations of the manual rotation knob 21 can be omitted, so as to achieve an effect of a reduction in cost.

In Embodiments 1 and 2 described above, in a case in which the sheet detecting sensor S2 has detected a jammed sheet in STEP 6, the CPU 3 of the controller 6 causes the light emitting diodes LED1 through LED4 of the fixing device 20 and the light emitting diodes LED5 through LED9 of the duplex printing device 30 to flash or light on. However, the configuration that can be applied to this disclosure is not limited thereto. For example, when both the sheet detecting sensors S2 and S3 have detected a jammed sheet, the CPU 3 may cause the light emitting diodes LED1 through LED4 of the fixing device 20 and the light emitting diodes LED5 through LED9 of the duplex printing device 30 to flash or light on.

Further, when the sheet detecting sensor S2 has detected a jammed sheet, the CPU 3 may cause the light emitting diodes LED1 through LED4 of the fixing device 20 to flash or light on to draw user's attention to remove the fixing device 20.

Further, the configurations of Embodiments 1 and 2 described above use the light emitting diodes LED1 through LED10. However, the configuration is not limited thereto. For example, a light emitting member such as a lamp can be employed.

The above-described embodiments are illustrative and do not limit this disclosure.

Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of this disclosure may be practiced otherwise than as specifically described herein.

What is claimed is:

1. An image forming apparatus comprising:
an apparatus body;
an image forming device disposed detachably attached to the apparatus body;
a sheet conveying path through which a recording medium travels in the image forming device;
a roller disposed along the sheet conveying path;
a rotary body configured to rotate the roller manually to remove the recording medium in paper jam; and
a guiding device including:
a sheet detector disposed along the sheet conveying path to detect the recording medium passing through the sheet conveying path; and
a guide configured to suggest removal of the image forming device to remove the recording medium in paper jam when the sheet detector no longer detects the recording medium,
the guide configured to suggest removal of the image forming device when the sheet detector detects the recording medium after a predetermined number of rotations of the rotary body.

2. The image forming apparatus according to claim 1,
wherein the guide includes a light emitter mounted on a front face of the image forming device, and
wherein the light emitter to flash or light on to suggest removal of the image forming device,

3. The image forming apparatus according to claim 2,
wherein the light emitter includes multiple light emitters,
wherein the image forming device includes a fixing device having a first light emitter of the multiple light emitters and a duplex printing device having a second light emitter of the multiple light emitter,
wherein the image forming apparatus further includes:
a controller to determine occurrence of paper jam based on detection of the recording medium by the sheet detector; and
a rotation detector to detect a number of rotation of the rotary body,
wherein, when the controller determines occurrence of paper jam in the fixing device, after the rotary body has been rotated and the sheet detector has no longer detected the recording medium, the controller causes the second light emitter of the duplex printing device to flash or light on to suggest removal of the duplex printing device, and
wherein, after the rotary body has been rotated and the rotation detector has detected a predetermined number of rotations of the rotary body, while the sheet detector continues to detect, the controller determines the recording medium between the fixing device and the duplex printing device and causes the first light emitter of the fixing device and the second light emitter of the duplex printing device to flash or light on to suggest removal of the fixing device and the duplex printing device.
